(19) United States
(12) Patent Application Publication
(10) Pub. No.: US 2013/0042013 A1
(43) Pub. Date: Feb. 14, 2013

(54) METHODS, APPARATUSES AND COMPUTER PROGRAM PRODUCTS FOR ENABLING LIVE SHARING OF DATA

(71) Applicant: Imed Bouazizi, Munich (DE)

(72) Inventor: Imed Bouazizi, Munich (DE)

(73) Assignee: Nokia Corporation

(21) Appl. No.: 13/207,189

(22) Filed: Aug. 10, 2011

(51) Int. Cl. G06F 15/16

(52) U.S. Cl. 709/228; 709/227

(57) ABSTRACT

An apparatus for implementing a live sharing session may include a processor and memory storing executable computer program code that cause the apparatus to at least perform operations including sending of a notification(s) to one or more devices. The notifications may include data informing the devices of an outstanding live sharing session. The computer program code may further cause the apparatus to provide representations to the devices for selection. The representations may relate in part to different representations of media content. The computer program code may further cause the apparatus to receive one or more requests for removing at least one of the representations or for receipt of one or more other representations of the media content and providing a final media presentation description to the devices, based at least in part on the removed representations or the requested representations. Corresponding methods and computer program products are also provided.

### TECHNOLOGICAL FIELD

An example embodiment of the present invention relates generally to a streaming session and more particularly, relates to an apparatus, method and a computer program product for facilitating an efficient and reliable mechanism of enabling sharing of data in a streaming session.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to services for sharing media data.

In this regard, traditionally, the Transmission Control Protocol (TCP) has been considered as not suitable for the delivery of real-time media such as audio and video content. This is mainly due to the aggressive congestion control algorithm and the retransmission procedure that TCP implements. When using TCP, the sender typically reduces the transmission rate significantly, e.g., typically by half, upon detection of a congestion event, typically recognized through packet loss or excessive transmission delays. As a consequence, the transmission throughput of TCP is usually characterized by a well-known saw-tooth shape. This behavior may be detrimental for streaming applications as these applications are typically delay-sensitive but relatively loss-tolerant, whereas TCP typically sacrifices delivery delay in favor of reliable and congestion-aware transmission. As such, it may beneficial to utilize a more efficient protocol for the delivery of multimedia content such as, for example, shared data over the Internet.

At present, TCP, in some instances, may be utilized for live sharing services in which a user may be able to record video and share it instantly with other users. The capture may be performed using a mobile device that is battery powered. The potential consumers are typically notified about the new sharing session and may be provided with the necessary information to enable consumption.

Current live sharing solutions may suffer from different drawbacks such as lack of support for multiple users or commercialization aspects related to third party provider usage. Another drawback may relate to restrictions on media encoding and power consumption being enforced for sources such as mobile devices providing live sharing sessions.

In view of the foregoing drawbacks, it may be beneficial to provide a reliable manner in which to enable sharing among multiple users simultaneously and efficiently without relying on third party commercial service support. Additionally, it may be beneficial to provide an efficient and reliable manner in which to enable a source to create a sufficient amount of media representations to meet the dynamic needs of one or more receivers.

### BRIEF SUMMARY

A method, apparatus and computer program product are therefore provided that may enable an efficient and reliable manner for implementing live sharing services using a transport protocol such as, for example, Adaptive HTTP Streaming. In this regard, an example embodiment may enable one or more receiving devices, also referred to herein as communication devices, to negotiate offered representations of media content at the start of a sharing session. By enabling negotiation of offered representations of media content, an example embodiment may trigger modifications to the representations at the start of the sharing session and/or during the lifetime of the session.

In this regard, an example embodiment may enable flexible realization of live sharing services using adaptive HTTP Streaming without requiring reliance third party service providers and by using a transport protocol such as, for example, the HTTP protocol which may simplify network management. Furthermore, an example embodiment allows the receiving devices to configure and modify the sharing session based on the needs and preferences of the receiving devices.

In one example embodiment, a method for implementing a live sharing session is provided. The method may include enabling sending of one or more notifications to one or more devices. The notifications may include data informing the devices of an outstanding live sharing session. The method may also include enabling provision of one or more representations to the devices for selection. The representations may relate in part to different representations of media content. The method may also include receiving one or more requests for removing at least one of the representations or for receipt of one or more other representations of the media content. The method may also include enabling provision of a final media presentation description to the devices. The final media presentation description may be based at least in part on the removed representations or the requested representations.

In another example embodiment, a computer program product for implementing a live sharing session is provided. The computer program product includes at least one computer-readable storage medium having computer-readable program code portions stored therein. The computer-readable program code portions, when executed by a processor, may cause an apparatus to enable sending of one or more notifications to one or more devices. The notifications may include data informing the devices of an outstanding live sharing session. The computer-readable program code portions of this embodiment, when executed by the processor, may also cause the apparatus to enable provision of one or more representations to the devices for selection. The representations may relate in part to different representations of media content. The computer-readable program code portions of this embodiment, when executed by the processor, may also cause the apparatus to receive one or more requests for removing at least one of the representations or for receipt of one or more other representations of the media content. The computer-readable program code portions of this embodiment, when executed by the processor, may also cause the apparatus to enable provision of a final media presentation description to the devices. The final media presentation description may be based at least in part on the removed representations or the requested representations.

In another example embodiment, an apparatus for implementing a live sharing session is provided. The apparatus may include a processor and a memory including computer program code. The memory and the computer program code are configured to, with the processor, cause the apparatus to at least perform operations including enabling sending of one or more notifications to one or more devices. The notifications may include data informing the devices of an outstanding live sharing session. The memory and the computer program code may also be configured to, with the processor, cause the apparatus to enable provision of one or more representations to the devices for selection. The representations may relate in part to different representations of media content. The memory and the computer program code may also be configured to, with the processor, cause the apparatus to receive one or more requests for removing at least one of the representations or for receipt of one or more other representations of the media content. The memory and the computer program code may also be configured to, with the processor, cause the apparatus to enable provision of a final media presentation description to the devices. The final media presentation description may be based at least in part on the removed representations or the requested representations.

In another example embodiment, an apparatus for implementing a live sharing session is provided. The apparatus may include means for enabling sending of one or more notifications to one or more devices. The notifications may include data informing the devices of an outstanding live sharing session. The apparatus may also include means for enabling provision of one or more representations to the devices for selection. The representations may relate in part to different representations of media content. The apparatus may also include means for receiving one or more requests for removing at least one of the representations or for receipt of one or more other representations of the media content. The apparatus may also include means for enabling provision of a final media presentation description to the devices. The final media presentation description may be based at least in part on the removed representations or the requested representations.

In another example embodiment, a method for implementing a live sharing session is provided. The method may include receiving a notification from a device. The notification may include data indicating an outstanding live sharing session and a request for joining the session. The method may also include receiving one or more representations from the device. The representations may relate in part to different representations of media content. The method may also include filtering the representations to request removal of at least one of the representations or request one or more other representations of the media content based at least in part on one or more device capabilities or one or more user preferences. The method may also include enabling sending of information indicating the filtered representations to the device and receiving a final media presentation description from the device. The final media presentation description may be based at least in part on the information indicating the filtered representations.

In another example embodiment, a computer program product for implementing a live sharing session is provided. The computer program product includes at least one computer-readable storage medium having computer-readable program code portions stored therein. The computer-readable program code portions, when executed by a processor, may cause an apparatus to receive a notification from a device. The notification may include data indicating an outstanding live sharing session and a request for joining the session. The computer-readable program code portions, when executed by a processor, may cause an apparatus to receive one or more representations from the device. The representations may relate in part to different representations of media content. The computer-readable program code portions, when executed by a processor, may also cause an apparatus to filter the representations to request removal of at least one of the representations or request one or more other representations of the media content based at least in part on one or more device capabilities or one or more user preferences. The computer-readable program code portions, when executed by a processor, may also cause an apparatus to enable sending of information indicating the filtered representations to the device and receiving a final media presentation description from the device. The final media presentation description may be based at least in part on the information indicating the filtered representations.

In another example embodiment, an apparatus for implementing a live sharing session is provided. The apparatus may include a processor and a memory including computer program code. The memory and the computer program code are configured to, with the processor, cause the apparatus to at least perform operations including receiving a notification from a device. The notification may include data indicating an outstanding live sharing session and a request for joining the session. The memory and the computer program code may also be configured to, with the processor, cause the apparatus to receive one or more representations from the device. The representations may relate in part to different representations of media content. The memory and the computer program code may also be configured to, with the processor, cause the apparatus to filter the representations to request removal of at least one of the representations or request one or more other representations of the media content based at least in part on one or more device capabilities or one or more user preferences. The memory and the computer program code may also be configured to, with the processor, cause the apparatus to enable sending of information indicating the filtered representations to the device and receive a final media presentation description from the device. The final media presentation description may be based at least in part on the information indicating the filtered representations.

In another example embodiment, an apparatus for implementing a live sharing session is provided. The apparatus may include means for receiving a notification from a device. The notification may include data indicating an outstanding live sharing session and a request for joining the session. The apparatus may also include means for receiving one or more representations from the device. The representations may relate in part to different representations of media content. The apparatus may also include means for filtering the representations to request removal of at least one of the representations or request one or more other representations of the media content based at least in part on one or more device capabilities or one or more user preferences. The apparatus may also include means for enabling sending of information indicating the filtered representations to the device. The apparatus may also include means for receiving a final media presentation description from the device. The final media presentation description may be based at least in part on the information indicating the filtered representations.

An example embodiment of the invention may provide a better user experience since one or more device capabilities and/or user preferences may be utilized to obtain media content in one or more preferred representations during a sharing session.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a diagram illustrating an Adaptive HTTP streaming architecture;

FIG. 2 is a diagram illustrating the structure of a Media Presentation Description according to an example embodiment of the invention;

FIG. 3 is a schematic block diagram of a system according to an example embodiment of the invention;

FIG. 4 is a schematic block diagram of a mobile terminal according to an example embodiment of the invention;

FIG. 5 is a schematic block diagram of a network device according to an example embodiment of the invention;

FIG. 6 is a schematic block diagram of a system according to an example embodiment of the invention;

FIG. 7 is a diagram of a notification message according to an example embodiment of the invention; and

FIGS. 8-12 illustrate flowcharts for implementing a live sharing session according to some example embodiments of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations, e.g., implementations in analog circuitry and/or digital circuitry; (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium, e.g., volatile or non-volatile memory device, can be differentiated from a “computer-readable transmission medium,” which refers to an electromagnetic signal.

The Hypertext Transfer Protocol (HTTP) is emerging as a practical alternative protocol for the delivery of multimedia content over the Internet. HTTP typically runs on top of TCP and is a textual protocol and may be deployed with ease. For instance, it is generally not necessary to deploy a dedicated server for delivering the content. Furthermore, HTTP is typically granted access through firewalls and network address translation devices (NATs) that may hinder other streaming methods and this may significantly simplify the deployment. Further, HTTP is widely deployed with a very robust infrastructure, including HTTP proxy servers and caches that enable efficient data distribution.

Adaptive HTTP streaming (AHS) solutions may be proprietary or standardized solutions. In Release 9 of the Third Generation Partnership Project (3GPP), a standardized solution for adaptive HTTP streaming is provided and the same solution has been adopted by several other standardization bodies such as, for example, Moving Picture Experts Group (MPEG) and Open Internet Protocol television (IPTV) Forum (OIPF). Several other proprietary solutions for adaptive HTTP streaming such as Apple's™ Live Streaming and Microsoft's™ Smooth Streaming are being commercially deployed. However, contrary to these other proprietary solutions, AHS is a fully open and standard-compatible standard, which drives inter-operability among different implementations.

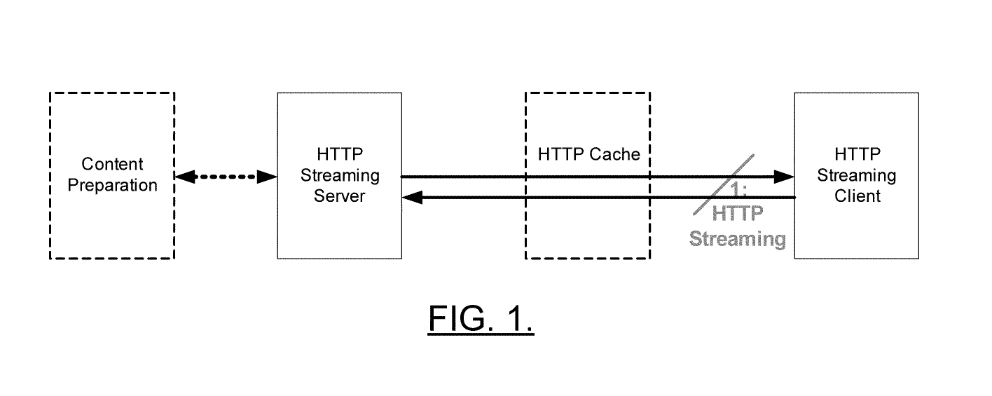

As shown in FIG. 1, in AHS, a content preparation step typically needs to be performed, in which the content is segmented into multiple segments. Typically, an initialization segment is created to carry the information necessary to configure a media player and then media segments may be consumed. The content is typically encoded in multiple bitrates and each encoding typically corresponds to a representation of the content. The content representations may be alternative to each other or they may complement each other. In the former case, a client device may select an alternative out of the group of alternative representations. Additionally, the client device may continue to add complementary representations that contain additional media components.

The content offered for AHS may be described to the client. This may be achieved using a Media Presentation Description (MPD) file. The MPD file may contain a description of the content and one or more representations of the content. Each representation may be an encoding of the content with a different configuration. In addition, the 3GPP adaptive HTTP streaming solution defines the session initiation procedure, which may be based on an Extensible Markup Language (XML) file, namely the Media Presentation Description (MPD).

In HTTP streaming, a media presentation may extend over one or more time periods. For each time period, there may be one or more representations of the content of the media presentation. For instance, each time period may include one or more representations of similar media content. Representations may differ with respect to bitrates, video or audio resolutions, languages, or the like. For example, for a particular time period, the different representations may be encoded at different bitrates and/or with different characteristics. A client device may then be able to select an appropriate media representation at the beginning of the period and also to switch between representations during the period. This ability to switch may enable rate adaptation in HTTP streaming, as the client device may select the representation that most closely matches its available throughput and may then switch between representations as the available throughput changes.

A representation may consist of an initialization segment and one or more following media segments. The initialization segment information may be included in each representation as metadata for accessing the media samples of each segment. The media segments may consist of one or more media fragments. A segment may include media data or metadata to decode and present the included media content. The MDP may include metadata that is usually used by a client device to access the segments needed to provide streaming media to a user. The MPD, for example, provides metadata for use in constructing a request, e.g., a GET request, for media segments containing media data. The MPD provides metadata regarding the number of representations as well as the characteristics of each representation. The MPD may provide unique uniform resource locators (URLs) or uniform resource identifiers (URIs) that may be used to locate and download each media segment for presentation. In streaming media segments, sequential requests and associated responses providing segments are usually performed. Accordingly, the MPD may be sent to a client device as metadata to facilitate the construction of the requests for the segments. The structure of a media presentation description is described more fully below.

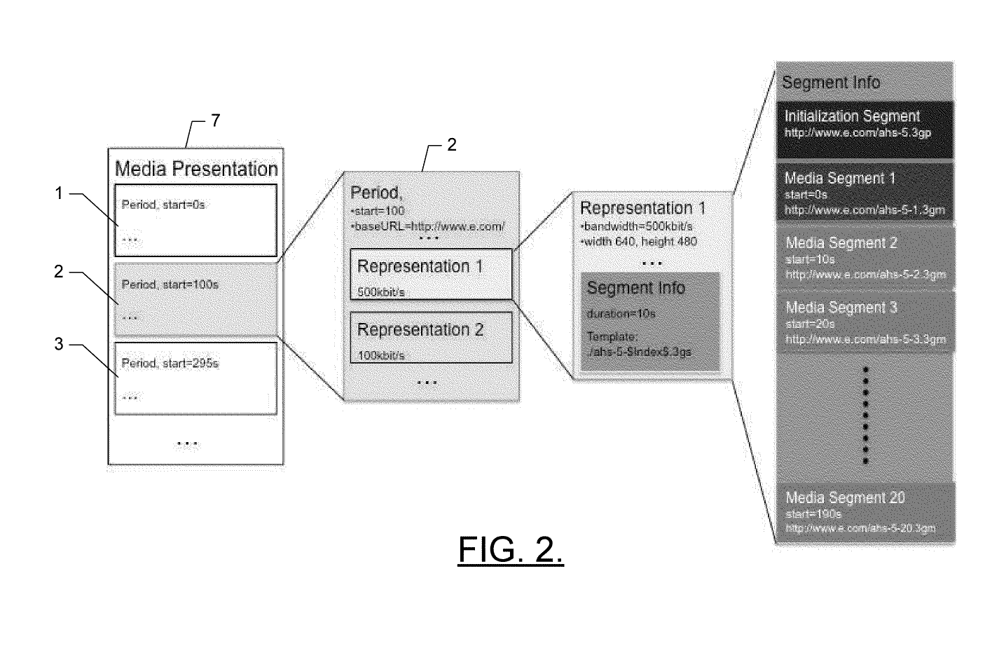

Referring to FIG. 2, a diagram illustrating the structure of a MPD according to an example embodiment is provided. The Media Presentation Description 7 of FIG. 2 may enable content offered for AHS to be described to a client device. In this regard, as described above, the MPD may be correspond to a XML file that may include a description of the content, the periods, e.g., periods 1, 2, 3, of the content, the representations, e.g., representation 5, of the content and an indication(s) relating to the manner in which to access each piece of the content. The MPD file 7 may include an MPD element which may include general information about the content, such as, for example, its type and the time window during which the content may be available. The MPD file may include one or more periods, each of which may describe a time segment of the content. Each period, e.g., period 2, may include one or more representations, e.g., representations 1, representation 2, of the content. Each representation, e.g., representation 1, of the content may be an encoding of the content with a different configuration. For instance, representations may differ in their bandwidth requirements, the media components they contain, the codecs in use, the languages, etc.

Accordingly, some example embodiments of the invention provide methods, apparatuses, and computer program products that may address some of the deficiencies of conventional media streaming techniques. For example, in order to facilitate sharing of streamed data during a sharing session, such as in adaptive HTTP streaming, a method, apparatus and computer program product are provided according to embodiments of the present invention that permit receiving devices to negotiate for modification of a MPD and may submit requests to source devices for providing streamed data in a preferred format in a reliable and efficient manner.

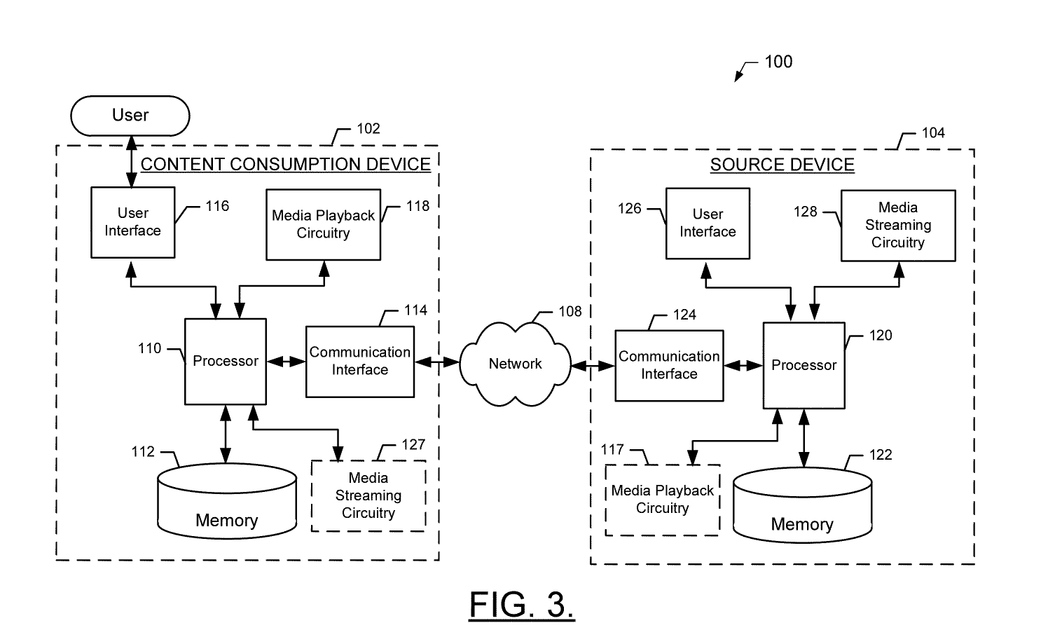

In this regard, FIG. 3 illustrates a block diagram of a system 100 for facilitating streaming of media files according to an example embodiment of the invention. It should be appreciated, however, that the scope of the disclosure encompasses many potential embodiments in addition to those illustrated and described herein. As such, while FIG. 3 illustrates one example of a configuration of a system for facilitating streaming of media files, numerous other configurations may also be used to implement embodiments of the present invention. Further, it should be appreciated that HTTP, e.g., AHS, may be used as an example of an application layer transfer protocol that may be used for streaming of media files in accordance with some embodiments of the invention. Other embodiments of the invention are configured to stream media files using other application layer transfer protocols in addition to or in lieu of HTTP.

FIG. 3 illustrates a block diagram of a system 100 for streaming media files using an application layer transfer protocol, such as HTTP, according to an example embodiment of the present invention. In the illustrated embodiment, the system 100 comprises a content consumption device 102, also referred to herein as receiving device 102, and a source device 104. The content consumption device 102 and the source device 104 are configured to communicate over a network 108. The network 108, for example, comprises one or more wireline networks, one or more wireless networks, or some combination thereof. The network 108 may comprise a public land mobile network (PLMN) operated by a network operator. In this regard, the network 108, for example, comprises an operator network providing cellular network access, such as in accordance with 3GPP standards. The network 108 may additionally or alternatively comprise the internet.

The content consumption device 102 may comprise any device configured to access content from a source device 104 over the network 108. For example, the content consumption device 102 comprises a server, a desktop computer, a laptop computer, a mobile terminal, a mobile computer, a mobile phone, a mobile communication device, a game device, a digital camera/camcorder, an audio/video player, a television device, a radio receiver, a digital video recorder, a positioning device, any combination thereof, and/or the like.

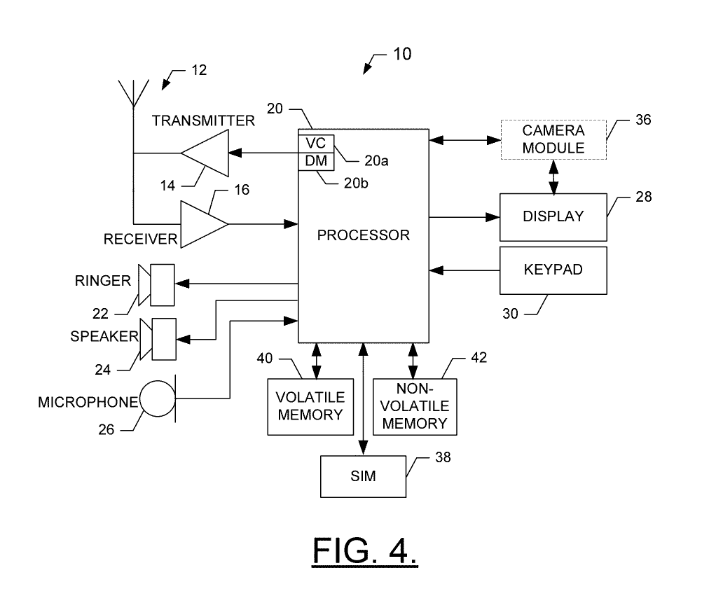

In an example embodiment, the content consumption device 102 and/or the source device 104 is embodied as a mobile terminal, such as that illustrated by way of example in FIG. 4. It should be understood, however, that the mobile terminal 10 illustrated and hereinafter described is merely illustrative of one type of content consumption device 102 that may implement and/or benefit from an example embodiment of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown in FIG. 4, the mobile terminal 10 may include an antenna 12 or multiple antennas 12 in communication with a transmitter 14 and a receiver 16. The mobile terminal may also include a processor 20 that provides signals to and receives signals from the transmitter and receiver, respectively. These signals may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136, Time Division Multiple Access (TDMA), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones, e.g., digital/analog or TDMA/CDMA/analog phones. Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits, such as, for example, an application specific integrated circuit (ASIC) or field programmable gate array (FPGA), or some combination thereof. The processor may additionally comprise an internal voice coder (VC) 20a, an internal data modem (DM) 20b, and/or the like. Further, the processor may comprise functionality to operate one or more software programs, which may be stored in memory. For example, the processor may be capable of operating a connectivity program, such as a web browser. The connectivity program may allow the mobile terminal 10 to transmit and receive web content, such as location-based content, according to a protocol, such as Wireless Application Protocol (WAP), HTTP, and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display, a joystick, and/or other input device. In embodiments including a keypad, the keypad may comprise numeric, e.g., 0-9, and related keys, e.g., #, *, and/or other keys for operating the mobile terminal.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include other a non-transitory memory including, but not limited to volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, e.g., hard disks, floppy disk drives, magnetic tape, etc., optical disc drives and/or media, non-volatile random access memory (NVRAM), and/or the like. Like volatile memory 40, non-volatile memory 42 may include a cache area for temporary storage of data. The memories may store one or more software programs, instructions, pieces of information, data, and/or the like which may be used by the mobile terminal, such as the processor 20, for performing functions of the mobile terminal. For example, the memories may comprise an identifier, such as an international mobile equipment identification (IMEI) code, capable of uniquely identifying the mobile terminal 10.

The mobile terminal 10 may optionally include a media capturing element, such as camera module 36. The camera module 36 may include a camera, video and/or audio module, in communication with the processor 20 and the display 28. The camera module 36 may be any means for capturing an image, video and/or audio for storage, display or transmission. For example, the camera module 36 may include a digital camera capable of forming a digital image file from a captured image. As such, the camera module 36 includes all hardware, such as a lens or other optical component(s), and software necessary for creating a digital image file from a captured image. Alternatively, the camera module 36 may include only the hardware needed to view an image, while a memory device, e.g., volatile memory 40, non-volatile memory 42, etc., of the mobile terminal 10 stores instructions for execution by the processor 20 in the form of software necessary to create a digital image file from a captured image. In an example embodiment, the camera module 36 may further include a processing element such as a co-processor which assists the processor 20 in processing image data and an encoder and/or decoder for compressing and/or decompressing image data. The encoder and/or decoder may encode and/or decode according to a Joint Photographic Experts Group, (JPEG) standard format or another like format. In some cases, the camera module 36 may provide live image data to the display 28. In this regard, the camera module 36 may facilitate or provide a camera view to the display 28 to show live image data, still image data, video data, or any other suitable data. Moreover, in an example embodiment, the display 28 may be located on one side of the mobile terminal 10 and the camera module 36 may include a lens positioned on the opposite side of the mobile terminal 10 with respect to the display 28 to enable the camera module 36 to capture images on one side of the mobile terminal 10 and present a view of such images to the user positioned on the other side of the mobile terminal 10.

Referring again to FIG. 3, in an example embodiment, the content consumption device 102 comprises various means, such as a processor 110, a memory 112, a communication interface 114, a user interface 116, media playback circuitry 118, and optionally media streaming circuitry 127, for performing the various functions herein described. The various means of the content consumption device 102 as described herein comprise, for example, hardware elements, e.g., a suitably programmed processor, combinational logic circuit, and/or the like, and/or a computer program product comprising computer-readable program instructions, e.g., software and/or firmware, stored on a computer-readable medium, e.g. memory 112. The program instructions are executable by a processing device, e.g., the processor 110. The processor 110 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an ASIC or a FPGA, or some combination thereof. Accordingly, although illustrated in FIG. 3 as a single processor, in some embodiments the processor 110 comprises a plurality of processors. The plurality of processors may be in operative communication with each other and may be collectively configured to perform one or more functionalities of the content consumption device 102 as described herein. In embodiments wherein the content consumption device 102 and/or the source device 104 is embodied as a mobile terminal 10, the processor 110 and/or the processor 120 may be embodied as or otherwise comprise the processor 20. In an example embodiment, the processor 110 is configured to execute instructions stored in the memory 112 or otherwise accessible to the processor 110. The instructions, when executed by the processor 110, cause the content consumption device 102 to perform one or more of the functionalities of the content consumption device 102 as described herein.

As such, whether configured by hardware or software operations, or by a combination thereof, the processor 110 may represent an entity capable of performing operations according to an example embodiment of the present invention when configured accordingly. For example, when the processor 110 is embodied as an ASIC, FPGA or the like, the processor 110 may comprise specifically configured hardware for conducting one or more operations described herein. Alternatively, as another example, when the processor 110 is embodied as an executor of instructions, the instructions may specifically configure the processor 110, which may otherwise be a general purpose processing element if not for the specific configuration provided by the instructions, to perform one or more operations described herein.

The memory 112 may include, for example, non-transitory memory, such as volatile and/or non-volatile memory. Although illustrated in FIG. 3 as a single memory, the memory 112 may comprise a plurality of memories. The memory 112 may comprise volatile memory, non-volatile memory, or some combination thereof. In this regard, the memory 112 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments in which the content consumption device 102 and/or source device 104 is embodied as a mobile terminal 10, the memory 112 and/or memory 122 may be embodied as or otherwise comprise the volatile memory 40 and/or non-volatile memory 42. The memory 112 may be configured to store information, data, applications, instructions, or the like for enabling the content consumption device 102 to carry out various functions in accordance with example embodiments of the present invention. For example, in at least some embodiments, the memory 112 is configured to buffer input data for processing by the processor 110. Additionally or alternatively, in at least some embodiments, the memory 112 is configured to store program instructions for execution by the processor 110. The memory 112 may store information in the form of static and/or dynamic information. This stored information may be stored and/or used by the media playback unit 118 during the course of performing its functionalities.

The communication interface 114 may be embodied as any device or means embodied in hardware, a computer program product comprising computer readable program instructions stored on a computer readable medium, e.g., the memory 112, and executed by a processing device, e.g., the processor 110, or a combination thereof that is configured to receive and/or transmit data from/to a remote device over the network 108. In at least one embodiment, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with other entities of the system 100, e.g., antenna 12, transmitter 14 and/or receiver 16 of mobile terminal 10 of FIG. 4. The communication interface 114 may be configured to receive and/or transmit data using any protocol that may be used for communications between computing devices of the system 100. The communication interface 114 may additionally be in communication with the memory 112, user interface 116, media playback circuitry 118, and/or media streaming circuitry 127 such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms, e.g., earphone or speaker 24, microphone 26, optionally camera module 36, display 28 and/or keypad 30 of mobile terminal 10 of FIG. 4. The user interface 116 may provide an interface allowing a user to select a media file and/or media tracks thereof to be streamed from the source device 104 to the content consumption device 102 for playback on the content consumption device 102. In this regard, for example, video from a media file may be displayed on a display of the user interface 116 and audio from a media file may be audibilized over a speaker of the user interface 116. The user interface 116 may be in communication with the memory 112, communication interface 114, media playback circuitry 118, and/or media streaming circuitry 127 such as via a bus.

The media playback circuitry 118 may be embodied as various means, such as hardware, a computer program product comprising computer readable program instructions stored on a computer readable medium, e.g., the memory 112, and executed by a processing device, e.g., the processor 110, or some combination thereof and, in one embodiment, is embodied as or otherwise controlled by the processor 110. In embodiments where the media playback circuitry 118 is embodied separately from the processor 110, the media playback circuitry 118 may be in communication with the processor 110. The media playback circuitry 118 may further be in communication with the memory 112, communication interface 114, media streaming circuitry 127 and/or user interface 116, such as via a bus.

The optional media streaming circuitry 127 may be embodied as various means, such as hardware, a computer program product comprising computer readable program instructions stored on a computer readable medium, e.g., the memory 112, and executed by a processing device, e.g., the processor 110, or some combination thereof and, in one embodiment, is embodied as or otherwise controlled by the processor 110. In embodiments wherein the media streaming circuitry 127 is embodied separately from the processor 110, the media streaming circuitry 127 may be in communication with the processor 110. The media streaming circuitry 127 may further be in communication with the memory 112, communication interface 114, and/or user interface 116, such as via a bus.

The source device 104 may comprise one or more computing devices configured to provide media files to a content consumption device 102. In at least one embodiment, the source device 104 may comprise one or more servers, e.g., HTTP servers, a desktop computer, a laptop computer, a mobile terminal, a mobile computer, a mobile phone, a mobile communication device, a game device, a digital camera/camcorder, an audio/video player, a television device, a radio receiver, a digital video recorder, a positioning device, any combination thereof and/or the like. As described above, in an example embodiment, the source device 104 is embodied as the mobile terminal 10 of FIG. 4. While the source device 104 may, but need not, be the source of the media files, the source device 104 may also be an intermediary for receiving the media files from one or more content sources and for providing the media files to the content consumption device 102. Also, in an alternative embodiment, the source device 104 may be configured to access content, e.g., streamed data, from a device, e.g., content consumption device 102, over network 108. In an example embodiment, the source device 104 includes various means, such as a processor 120, memory 122, communication interface 124, user interface 126, optionally media playback circuitry 117, media streaming circuitry 128 for performing the various functions herein described. These means of the source device 104 as described herein may be embodied as, for example, hardware elements, e.g., a suitably programmed processor, combinational logic circuit, and/or the like, a computer program product comprising computer-readable program instructions, e.g., software or firmware, stored on a computer-readable medium, e.g., memory 122 that is executable by a suitably configured processing device, e.g., the processor 120, or some combination thereof.

The processor 120 may, for example, be embodied as various means including one or more microprocessors with accompanying digital signal processor(s), one or more processor(s) without an accompanying digital signal processor, one or more coprocessors, one or more controllers, processing circuitry, one or more computers, various other processing elements including integrated circuits such as, for example, an ASIC or FPGA, or some combination thereof. In example embodiments wherein the source device 104 is embodied as the mobile terminal 10, the processor 120 may be embodied as or otherwise comprise the processor 20. Accordingly, although illustrated in FIG. 3 as a single processor, in some embodiments the processor 120 comprises a plurality of processors. The plurality of processors may be embodied on a single computing device or distributed across a plurality of computing devices. The plurality of processors may be in operative communication with each other and may be collectively configured to perform one or more functionalities of the source device 104 as described herein. In an example embodiment, the processor 120 is configured to execute instructions stored in the memory 122 or otherwise accessible, e.g., memories 40, 42, to the processor 120. These instructions, when executed by the processor 120, may cause the source device 104 to perform one or more of the functionalities of source device 104 as described herein. As such, whether configured by hardware or software methods, or by a combination thereof, the processor 120 may represent an entity capable of performing operations according to embodiments of the present invention when configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, the instructions may specifically configure the processor 120, which may otherwise be a general purpose processing element if not for the specific configuration provided by the instructions, to perform one or more algorithms and operations described herein.

The memory 122 may include, for example, volatile and/or non-volatile memory. Although illustrated in FIG. 3 as a single memory, the memory 122 may comprise a plurality of memories, which may be embodied on a single computing device or distributed across a plurality of computing devices. The memory 122 may comprise non-transitory memory, such as volatile memory, non-volatile memory, or some combination thereof. In this regard, the memory 122 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the source device 104 to carry out various functions in accordance with embodiments of the present invention, as described herein. For example, in at least some example embodiments, the memory 122 is configured to buffer input data for processing by the processor 120. Additionally or alternatively, in at least some embodiments, the memory 122 is configured to store program instructions for execution by the processor 120. The memory 122 may store information in the form of static and/or dynamic information. This stored information may be stored and/or used by the media streaming circuitry 128, also referred to herein as media streaming unit 128, during the course of performing its functionalities.

The communication interface 124 may be embodied as any device or means embodied in hardware, a computer program product comprising computer readable program instructions stored on a computer readable medium, e.g., the memory 122, and executed by a processing device, e.g., the processor 120, or a combination thereof that is configured to receive and/or transmit data from/to a remote device over the network 108. In at least one embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with other entities of the system 100. The communication interface 124 may be configured to receive and/or transmit data using any protocol that may be used for communications between computing devices of the system 100. The communication interface 124 may additionally be in communication with the memory 122, user interface 126, media streaming circuitry 128, and/or media playback circuitry 117 such as via a bus.

The user interface 126 is optional and may be in communication with the processor 120 to receive an indication of a user input and/or to provide an audible, visual, mechanical, or other output to the user. As such, the user interface 126 may include, for example, a keyboard, keypad 30 a mouse, a joystick, a display 28, a touch screen display, optionally camera module 36, a microphone 26, a speaker 24, and/or other input/output mechanisms such as, for example of mobile terminal 10 of FIG. 4. In some embodiments, the user interface 126 may be limited, or even eliminated. The user interface 126 may be in communication with the memory 122, communication interface 124, media streaming circuitry 128, and/or media playback circuitry 117 such as via a bus.

The media streaming circuitry 128 may be embodied as various means, such as hardware, a computer program product comprising computer readable program instructions stored on a computer readable medium, e.g., the memory 122, and executed by a processing device, e.g., the processor 120, or some combination thereof and, in one embodiment, is embodied as or otherwise controlled by the processor 120. In embodiments wherein the media streaming circuitry 128 is embodied separately from the processor 120, the media streaming circuitry 128 may be in communication with the processor 120. The media streaming circuitry 128 may further be in communication with the memory 122, communication interface 124, user interface 126, and/or medial playback circuitry 117, such as via a bus.

The optional media playback circuitry 117 may be embodied as various means, such as hardware, a computer program product comprising computer readable program instructions stored on a computer readable medium, e.g., the memory 122, and executed by a processing device, e.g., the processor 120, or some combination thereof and, in one embodiment, is embodied as or otherwise controlled by the processor 120. In embodiments where the media playback circuitry 117 is embodied separately from the processor 120, the media playback circuitry 117 may be in communication with the processor 120. The media playback circuitry 117 may further be in communication with the memory 122, communication interface 124, and/or user interface 126, such as via a bus.

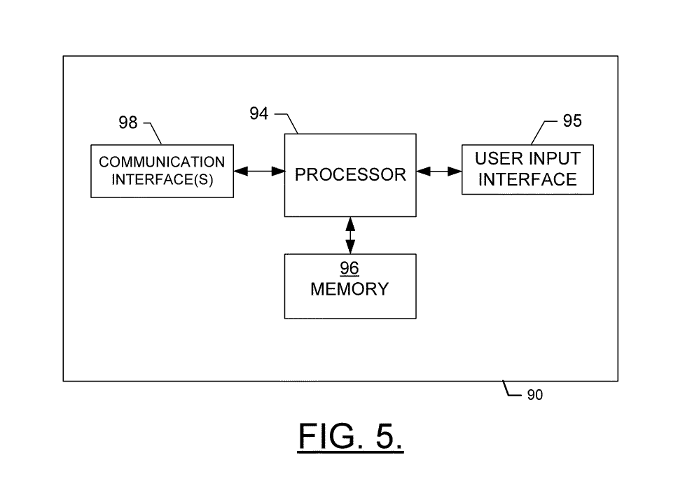

Referring now to FIG. 5, a block diagram of an example embodiment of a network device is provided. As shown in FIG. 5, the network device 90, e.g., a server, generally includes a processor 94 and an associated memory 96. The memory 96 may comprise volatile and/or non-volatile memory, and may store content, data and/or the like. The memory 96 may store client applications, instructions, and/or the like for the processor 94 to perform the various operations of the network device 90.

The processor 94 may also be connected to at least one communication interface 98 or other means for displaying, transmitting and/or receiving data, content, and/or the like. The user input interface 95 may comprise any of a number of devices allowing the network device 90 to receive data from a user, such as a keypad, a touch display, a joystick or other input device. In this regard, the processor 94 may comprise user interface circuitry configured to control at least some functions of one or more elements of the user input interface. The processor and/or user interface circuitry of the processor may be configured to control one or more functions of one or more elements of the user interface through computer program instructions (e.g., software and/or firmware) stored on a memory accessible to the processor, e.g., volatile memory, non-volatile memory, and/or the like.

The network device 90 may communicate with one or more devices, e.g., content consumption device 102 and/or source device 104 in one embodiment, for the exchange of media data including but not limited to one or more media files, and any other suitable data. In an example embodiment, the network device may be an intermediary device for receiving media data from one or more content sources, e.g., source device 104, and for providing the media data to one or more content consumption devices 102.

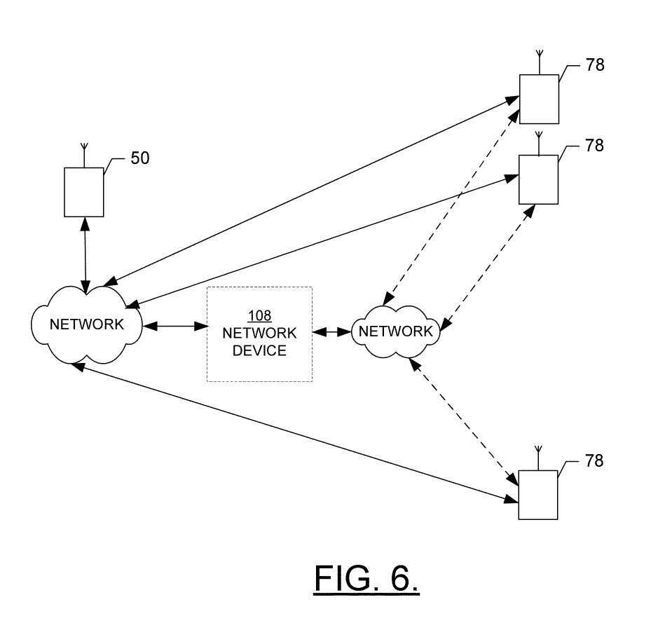

Referring now to FIG. 6, an example embodiment of a system is provided. The system may include a source apparatus 50, e.g., source device 104, communication devices 78, e.g., content consumption devices 102, and a network device 108, also referred to herein as a support server 108, e.g., network device 90. Although one source apparatus 50, three communication devices 78 and one network device 108 are shown in FIG. 6, it should be pointed out that any suitable number of source apparatuses 50, communication devices 78 and network devices 108 may be included in the system of FIG. 6 without departing from the spirit and scope of the invention.

In one example embodiment, the source apparatus 50 may embody a web server for storing media content following preparation and in anticipation of streaming the media content to one or more communication devices, as described below. The source apparatus 50 may share data, e.g., live data, directly, with one or more of the communication devices 78, via a network. The source apparatus 50 may share the data with the communication devices 78 by implementing server, e.g., a HTTP server, a Representational State Transfer (REST) server, etc., capabilities, as described more fully below. The source apparatus 50 may share media data, e.g., live data, data streamed in real time, with one or more of the communication devices 78 in response to capturing the media data, segmenting the media and offering the media to one or more of the communication devices 78, as described more fully below. The shared data may be provided by the source apparatus 50 to the communication devices 78 in an MPD, for example.

In an alternative example embodiment, the source apparatus 50 may capture and segment the media data, e.g., video data, etc., in the manner described below, and may send the generated segments of the media data to the support server 108, e.g., a web server (e.g., HTTP server. In this regard, the support server 108 may send the generated media segments to one or more of the communication devices 78. The generated media segments may be sent by the support server 108 to one or more of the communication devices in an MPD, e.g., a MPD file. Upon receipt of the media segments, the communication devices 78 may execute the media data, e.g., play the media data, or alternatively the communication devices 78 may request one or more different representations of the segmented media data from the support server 108. In this regard, the support server 108 may directly provide the requested different representations of the segmented media data to one or more of the communication devices 78. Alternatively, the support server 108 may send the request for the different representations to the source apparatus 50 and upon receipt of the different representations from the source apparatus 50, the support server 108 may send the different representations to one or more of the communication devices 78. The different representations may be sent by the support server 108 in a modified MPD to one or more of the communication devices 78.

An example embodiment for generating media content for sharing will now be described for purposes of illustration and not of limitation. In this regard, media content may be created by the source apparatus 50 or by another source of the media content. For example, the media content may be captured, such as by one or more video cameras, one or more audio recorders or the like, or otherwise accessed, such as from a database, another device or the like. Once created, the media content may be prepared, by the media streaming circuitry 128, for streaming to one or more of the communication devices 78. In this regard, the media content may be segmented such that the resulting media content is comprised of a plurality of segments that generally have a temporal relationship to one another. One or more of the segments may also be fragmented with a respective segment having a plurality of fragments that may also have a temporal relationship to one another. The preparation of the media content including, for example, the segmentation and fragmentation of the media content, may be performed by the processor 120 and/or media streaming circuitry 128. Alternatively, the preparation of the media content including, for example, the segmentation and fragmentation, may be performed by a media segmenter, such as, for example, a server or the like. Following its preparation, the segmented media content may be stored by or in association with a device, such as for example, a web server. In this regard, the source apparatus 50 may embody the web server, as described above, for storing the media content following preparation in anticipation of streaming the media content to one or more of the communication devices 78, as described below. The source apparatus 50 may store the segmented media content in memory 122 so as to be accessible to the processor 120 for causing streaming of the segmented media content to one or more of the communication devices 78.

Multiple representations of the media content may be created, prepared and stored, by the media streaming circuitry and/or processor 120. As noted above, the different representations may differ from one another in terms of bit rate or other characteristics, including but not limited to video or audio resolutions, languages, or the like, etc. Additionally, multiple types of media content for the same time period may be created, prepared and stored including, for example, video content, audio content, subtitle content and/or the like. Each different type of media content may have a plurality of different representations. These different representations of the media content may by included in a MPD, e.g., a MPD file, by the media streaming circuitry 128 and/or processor 120, and may be sent by the source apparatus 50 to one or more of the communication devices 78. The source apparatus 50 may send the MPD to one or more communication devices 78 that a user of the source apparatus 50 may desire to communicate with in a live sharing session for streaming the created or captured media content.

Upon receipt of the MPD sent from the source apparatus 50, one or more of the communication devices 78 may examine the contents/data of the MPD and may determine that the corresponding communication device(s) 78 prefers a different representation (e.g., a different video resolution, etc.) of the media content other than the representations identified in the received MPD. For example, the corresponding communication device(s) 78 may determine that it does not support the representations, e.g., high video resolutions, etc., provided in the MPD initially sent by the source apparatus 50. In this regard, a corresponding communication device(s) 78 desiring a different representation may filter the MPD and may modify the MPD by including one or more requests for preferred representations, e.g., a higher video resolution, etc., in the MPD. The communication device(s) 78 desiring one or more other representations may send the modified MPD to the source apparatus 50. In this regard, the source apparatus 50 may examine the modified MPD and may attempt to accommodate the corresponding desire of the communication device(s) 78 by providing the corresponding media content in the requested representation or a highest preferred representation identified by the communication device(s) 78 that the source apparatus 50 is capable of accommodating, as described more fully below.

For purposes of illustration and not of limitation, consider an example in which a user of a source apparatus 50, e.g., source device 104, attends an event, e.g., a party, and while attending the event the camera module 36 of the source apparatus 50 is being executed to capture video. Consider further that the user of the source apparatus 50 knows of some individuals that may be interested in the event that are not present and as such the user desires to stream the video data being recorded live to devices, e.g., communication devices 78, of these individuals. In this regard, the source apparatus 50 may send notifications to the devices of the individuals informing them about a forthcoming live sharing session and including information for joining the session. For example, the notifications generated by the media streaming circuitry 128 and/or processor 120 may be sent by the source apparatus 50 to devices of individuals of interest in a message, e.g., a Short Message Service (SMS) message, an email message, etc. Additionally or alternatively, the source apparatus 50 may provide the notification(s) to an account of a social network service, e.g., Facebook™, Twitter™, LinkedIn™, MySpace™, etc., maintained by the individuals or the notification(s) may be sent as part of an ongoing phone call.

The notification(s) generated by the media streaming circuitry 128 and/or processor 120 may include an invitation to join the live sharing session, a pointer to the unfiltered Media Presentation Description (MPD), instructions about the filtering, information regarding a deadline for receiving filtering desires, e.g., desires of a device(s) e.g., a communication device(s) 78 and/or an individual(s). In an example embodiment, the notification message may be formatted in XML.

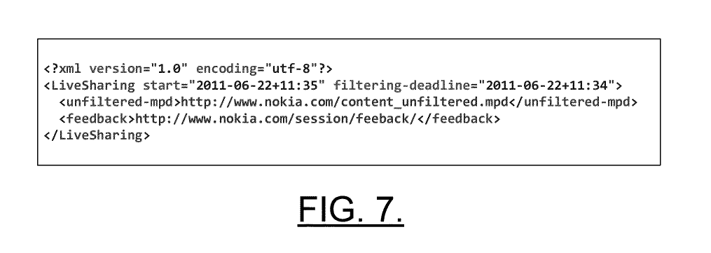

Referring now to FIG. 7, an example embodiment of a notification message is provided. The notification message of FIG. 7 may correspond to an XML fragment. The example embodiment of the notification message of FIG. 7 may include a link, e.g., a uniform resource locator (URL) to an unfiltered, (e.g., unmodified, MPD, which a receiving device(s), e.g., communication device(s) 78, may use to filter the offered data. As shown in FIG. 7, the notification message may also include the time starting from which requests for the filtered MPD and for media segments may be sent. Additionally, the notification message may include data identifying a deadline for accepting filtering requests from one or more devices (e.g., communication devices 78).

In this example, the unfiltered MPD generated by media streaming circuitry 128 and/or processor 120 may include one or more different representations related to the same media content. For instance, in the example above, related to the capture of the video data during the event, the different representations may relate to varying representations of the same video data. For purposes of illustration and not of limitation, the different representations may relate to different bit rates of the video data, different video resolutions of the data, etc. In one example embodiment, these different representations may be based on preferences and/or defaults of the source apparatus 50. In another example embodiment, these different representations may relate to representations that the source apparatus 50 is configured to support, e.g., device capabilities.

In response to receiving a notification message, a device of an interested individual (e.g., an individual being requested to join the live sharing session) may analyze the unfiltered MDP and determine whether to request other representations that may not be included in the unfiltered MPD. For example, upon receipt of an unfiltered MPD, a receiving device (e.g., communication device 78) may inspect the unfiltered MPD and may remove unsupported representations and may sort the representations based on user and device preferences. For example, a receiving device may not support a particular bit rate, e.g., a high bit rate, corresponding to a representation of media content. However, the receiving device may have preferences for bit rates that the receiving device is capable of supporting. Additionally, the receiving device may have preferences regarding representations based on user preferences. For example, the user may set a preference for the type of video resolution that he/she would like a corresponding receiving device to receive. The device and/or user preferences may be utilized by the media playback circuitry 118 and/or processor 110 of a receiving device, e.g., a communication device 78, to modify the MPD initially sent by the source apparatus 50. The resulting filtered MPD, e.g., a modified MPD, may then be submitted by a receiving device to the source apparatus 50. In an example embodiment, the filtered MPD may be provided to the source apparatus 50 based in part on a feedback URL, for example using a RESTful application programming interface (API). In an alternative example embodiment, instead of sending the source apparatus 50 a filtered MPD, the media playback circuitry 118 and/or processor 110 may send the source apparatus 50 one or more identifiers indicating the preferred representations. By sending the identifiers indicating the preferred representations, the receiving device may eliminate redundancy and may save bandwidth.

An example of a filtering request generated by the media playback circuitry 118 and/or processor 110 of a receiving device(s) such as, for example, a communication device(s) 78 is provided below for purposes of illustration and not of limitation.

http://www.nokia.com/session/feedback/filtering/representations?ids=3,5,6,8

The above link uses the provided feedback URL and may include filtering information associated with a RESTful API. The provided representation identifiers (IDs), e.g., ids, 3, 5, 6, 8 may be sorted based on the preferences, e.g., device and/or user preferences.

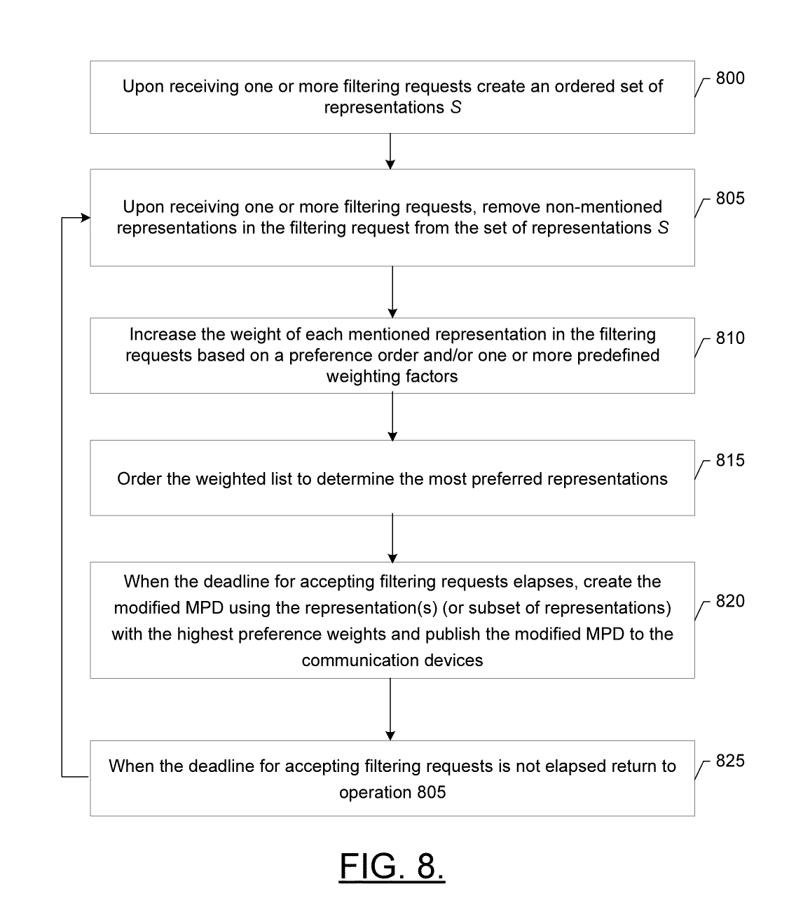

As shown in operation 800 of FIG. 8, upon receiving one or more filtering requests corresponding to one or more filtered MPDs from one or more communication devices 78, the source apparatus 50 may perform the filtering. In this regard, the source apparatus 50 may analyze the data of the filtered MPDs and may create or generate an ordered set of representations S. The ordered set of representations S may be based on the combined filtered MPDs which may be received from communication devices 78. For instance, consider an example in which a filtering request may be sent from one communication device 78 requesting a representation with a high bit rate and another filtering request sent from another communication device 78 requesting a representation with a low bit rate. In this regard, the source apparatus 50 may generate an ordered set of representations S including the lower bit rate for the media content since both communication devices 78 should be able to handle the lower bit rate and since one of the communication devices 78 may be unable to support the higher bit rate. Alternatively, in another example embodiment, in an instance in which the source apparatus 50 determines that it may be unable to accommodate the filtering requests of one or more communication devices, for example, the source apparatus 50 is unable to support the representation(s) being requested, the source apparatus 50 may include a default representation(s) in the ordered set of representations S.

Additionally or alternatively, in an instance in which one or more filtering requests are received from one or more communication devices, the source apparatus 50 may analyze the data of the filtering requests and may remove non-mentioned representations in the filtering request from the ordered set of representations S. See operation 805. For example, the source apparatus 50 may determine based on analyzing the filtering requests received that none of the communication devices 78 are interested in one or more particular representations in the initial MPD sent to the communication devices 78. In this regard, the source apparatus 50 may decide to remove one or more particular representations from the ordered set of representations S.

At operation 810, the source apparatus 50 may increase the weight of each mentioned representation in one or more filtering requests received from one or more communication devices 78 based in part on a preference order of the source apparatus 50 and/or based on predefined weighting factors. For example, the source apparatus 50 may increase a weight of each mentioned representation in the filtering requests based on a number of times the particular representation is mentioned by the communication devices 78, for example. For instance, the source apparatus 50 may receive multiple filtering requests and in an instance in which, for example, many requests may indicate interest in one particular representation, the source apparatus 50 may assign more weight to the particular representation(s).

At operation 815, the source apparatus 50 may order the weighted preferences and may arrange the weighted preferences in an ordered list based on the most preferred representations. At operation 820, the source apparatus 50 may determine whether a deadline for accepting one or more filtering requests from one or more communication devices 78 has elapsed and if so, the source apparatus 50 may create the modified MPD using the representations with the highest preference weights and may publish the modified (e.g., unfiltered) MPD to the corresponding communication devices 78. At operation 825, in an instance in which the source apparatus 50 determines that the deadline for accepting filtering requests has not elapsed, the source apparatus 50 may remove non-mentioned representations in the filtering request from representation S, as per operation 805.

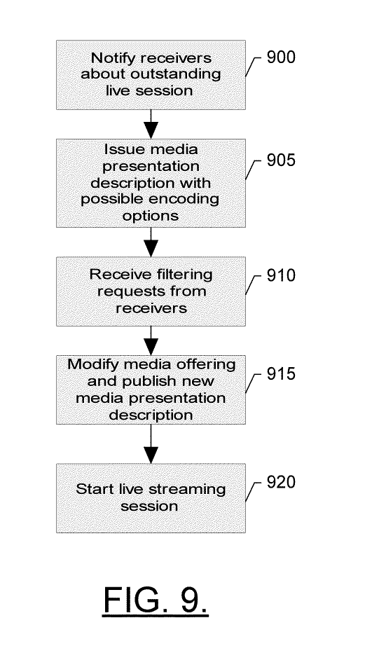

Referring now to FIG. 9, a flowchart of an example method for enabling provision of a sharing session is provided. At operation 900, an apparatus, e.g., source apparatus 50, may notify one or more receiving devices, e.g., communication devices 78, about an outstanding or forthcoming live sharing session. An outstanding or forthcoming live sharing session may relate to a current or a future live sharing session. At operation 905, an apparatus, e.g., source apparatus 50, may use a Media Presentation Description with one or more encoding options such as, for example, one or more representations of media content. At operation 910, an apparatus (e.g., source apparatus 50) may receive one or more filtering requests from one or more receivers. At operation 915, an apparatus, e.g., source apparatus 50, may modify one or more media offerings and may publish a new or modified MPD. At operation 920, an apparatus, e.g., source apparatus 50, may start a live streaming session with one or more receiving devices.

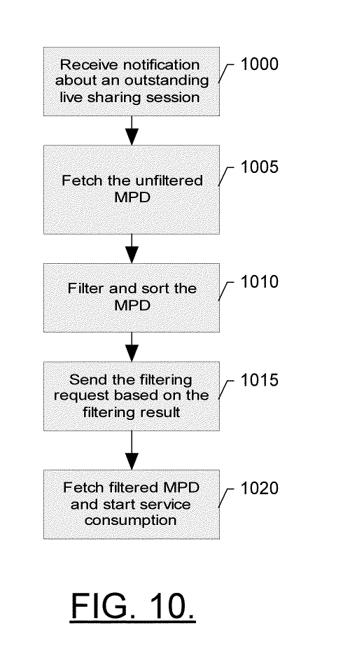

Referring now to FIG. 10, a flowchart of an example method for enabling filtering of an MPD is provided. At operation 1000, one or more receiving devices, e.g., communication devices 78, may receive a notification(s) regarding an outstanding or forthcoming live sharing session. At operation 1005, one or more of the receiving devices may fetch or receive an unfiltered MPD. The unfiltered MPD may be received from a source apparatus, e.g., source apparatus 50. At operation 1010, one or more of the receiving devices may filter and sort the MPD received from a source apparatus. At operation 1015, one or more of the receiving devices may send a filtering request to a source apparatus based on the filtering result, e.g., filtering the MPD. At operation 1020, one or more of the receiving devices may fetch or receive a filtered MPD from a source apparatus and may start service consumption to obtain shared data via the live sharing session.

During the lifetime of a sharing session, the receiving devices, e.g., communication devices 78, may continuously monitor, for example, via processor 110, their connection and may measure net throughput. As the number of representations offered may be limited, for example, one or a few representations offered due to encoding complexity, adaptation of a connection may not be performed solely by a corresponding receiving device(s). Instead, the source apparatus 50 may enable control operations, so that one or more receiving devices participating in the sharing session may send one or more adaptation requests to the source apparatus 50. The adaptation requests may include information relating to the connection informing the source apparatus 50 of changes, e.g., throughput changes, in the connection.

In an instance in which a receiving device(s) notices or detects a significant drop or increase in measured throughput, the corresponding receiving device(s) may inform the source apparatus 50 of the drop or increase in throughput. A receiving device(s) may detect a change in throughput, for example, in an instance in which a network connection becomes slow or fast, when a quality of a network connection is reliable or network connection's quality becomes poor, or when a receiving device(s) switches from a 2G network to a 3G network or for any other suitable reasons that may affect the throughput of a connection.

The receiving device(s) may inform the source apparatus 50 of the changes in throughput via an adaptation request message. The adaptation request message may also indicate one or more desires of a corresponding receiving device to receive one or more different representations based on the change in throughput. For example, in an instance in which a connection has a poor quality, the receiving device(s) may request, in the adaptation request message, a representation for a different bit rate such as, for example, a lower bit rate associated with media data. As another example, in an instance in which the connection is high quality, the receiving device(s) may include data in the adaptation request message requesting a representation corresponding to a higher bit rate associated with the media data.

In one example embodiment, the receiving devices may inform the source apparatus 50 of the changes in throughput by utilizing HTTP and in this regard, the receiving devices may utilize a RESTful API to communicate the adaptation request messages.

Based on receipt of the throughput information and/or requests for different representations, for example, in an adaptation request message, from one or more receiving devices, the source apparatus 50 may determine whether to modify a current sharing session. In an instance in which the source apparatus 50 determines to modify the sharing session, the source apparatus 50 may generate a new MPD, or a modified MPD, and may inform each receiving device participating in the sharing session about the newly available MPD. For example, the source apparatus 50 may inform each of the receiving devices participating in the sharing session by providing the new MPD, e.g., a modified MPD to each of the receiving devices. The new MPD may, but need not, include one or more of the different representations requested by one or more of the receiving devices based in part on the detected changes in throughput. In this regard, the source apparatus 50 may, but need not, generate the new MPD based in part on the aggregation of bandwidth requests, e.g., choosing the minimum requested bandwidth from requests received during a time interval T, received from one or more of the receiving devices. In order to avoid throttling the connection unnecessarily, the receiving devices may periodically send bandwidth requests, e.g., more often than 1/T, to the source apparatus 50 even if no changes, e.g., throughput changes, are measured.

In one example embodiment, the source apparatus 50 may use other forms of feedback such as, for example, one or more Quality of Experience (QoE) metric reports that may be periodically sent by the receiving devices to the source apparatus 50 to generate a new or modified MPD. In this regard, the QoE metric reports may include data indicating a network environment, network conditions, e.g., data indicating the type of network, or the like and the source apparatus 50 may utilize this information in part to generate a new or modified MPD. The QoE metric reports may also, for example, include data indicating one or more capabilities of a receiving device such as, for example, the type of display a receiving device is using or the type of coding supported by a receiving device and the source apparatus 50 may utilize this information associated with the capabilities of the receiving devices to generate a new or modified MPD.

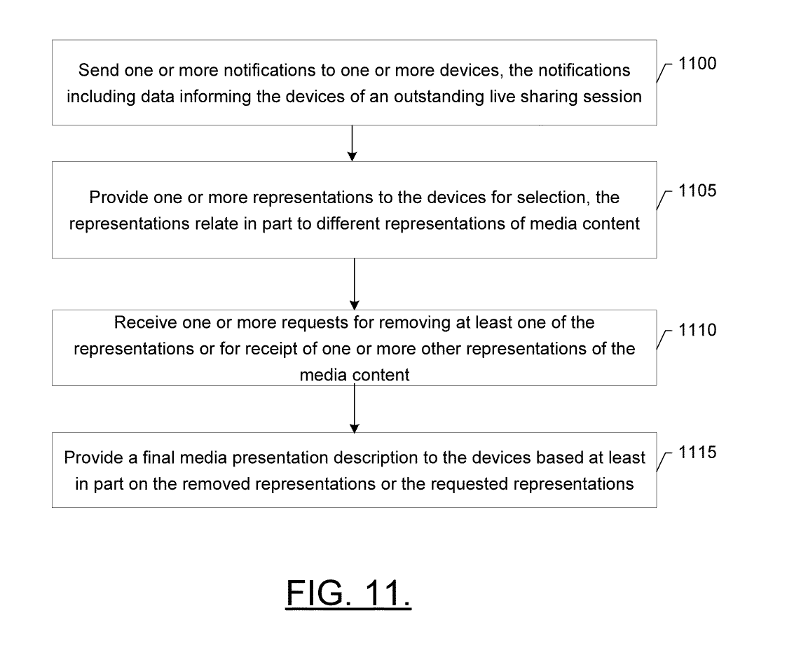

Referring now to FIG. 11, an example embodiment of a flowchart implementing a live sharing session is provided. At operation 1100, an apparatus, e.g., source apparatus 50, may send of one or more notifications to one or more devices, e.g., communication devices 78. The notifications, e.g., the notification message of FIG. 7, may include data informing the devices of an outstanding live sharing session. An outstanding live session may relate to a current or future live sharing session. At operation 1105, an apparatus, e.g., source apparatus 50, may provide one or more representations to the devices for selection. The representations may relate in part to different representations of media content, e.g., video data, image data, audio data, etc. The different representation may be provided in an initial MPD and the different representations may relate to the same, or similar, media content. At operation 1110, an apparatus, e.g., source apparatus 50, may receive one or more requests (e.g., a filtering request(s)) for removing at least one of the representations or for receipt of one or more other representations of the media content. At operation 1115, an apparatus, e.g., source apparatus 50, may provide a final media presentation description, e.g., a modified MPD, to the devices, based at least in part on the removed representations or the requested representations.

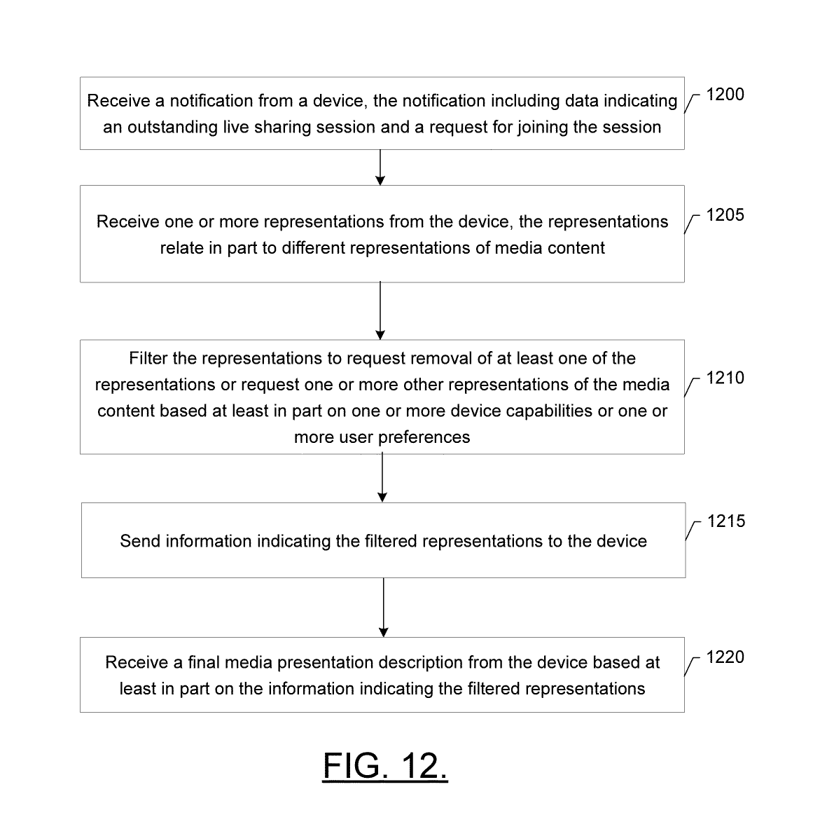

Referring now to FIG. 12, an example embodiment of a flowchart for participating in a live sharing session is provided. At operation 1200, an apparatus, e.g., a communication device 78, may receive a notification from a device, e.g., source apparatus 50. The notification (e.g., notification message of FIG. 7) may include data indicating an outstanding live sharing session and a request for joining the session. At operation 1205, an apparatus, e.g., communication device 78, may receive one or more representations from the device (e.g., source apparatus 50). The representations may relate in part to different representations of media content.

At operation 1210, an apparatus, e.g., a communication device 78, may filter the representations to request, e.g., a filtering request, removal of at least one of the representations or request one or more other representations of the media content based at least in part on one or more device capabilities, e.g., display capabilities, coding capabilities, etc. of communication device 78, or one or more user preferences, e.g., a user establishing a preference to share data at a particular bitrate or video resolution, etc. At operation 1215, an apparatus, e.g., communication device 78, may send information indicating the filtered representations to the device, e.g., source apparatus 50. At operation 1220, an apparatus, e.g., communication device 78, may receive a final media presentation description, e.g., a modified MPD, from the device based at least in part on the information, e.g., a filtering request, indicating the filtered representations.

It should be pointed out that FIGS. 8-12 are flowcharts of a system, method and computer program product according to some example embodiments of the invention. It will be understood that each block of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in some example embodiments, the computer program instructions which embody the procedures described above are stored by a memory device, for example, memory device 112, memory 122, volatile memory 40, non-volatile memory 42, and executed by a processor, for example, processor 20, processor 110, processor 120. As will be appreciated, any such computer program instructions may be loaded onto a computer or other programmable apparatus, for example, hardware, to produce a machine, such that the instructions which execute on the computer or other programmable apparatus cause the functions specified in the flowcharts blocks to be implemented. In some example embodiments, the computer program instructions are stored in a computer-readable memory that can direct a computer or other programmable apparatus to function in a particular manner, such that the instructions stored in the computer-readable memory produce an article of manufacture including instructions which implement the function(s) specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some example embodiments, an apparatus for performing the methods of FIGS. 8-12 above may comprise a processor, for example, the processor 20, the processor 110, the processor 120, configured to perform some or each of the operations, 800-825, 900-920, 1000-1020, 1100-1115, 1200-1220, described above. The processor may, for example, be configured to perform the operations, 800-825, 900-920, 1000-1020, 1100-1115, 1200-1220, by performing hardware implemented logical functions, executing stored instructions, or executing algorithms for performing each of the operations. Alternatively, the apparatus may comprise means for performing each of the operations described above. In this regard, according to some example embodiments, examples of means for performing operations, 800-825, 900-920, 1000-1020, 1100-1115, 1200-1220, may comprise, for example, the processor 20, for example, as means for performing any of the operations described above, the processor 110, the processor 120 and/or a device or circuitry, e.g., media playback circuitry 118, media streaming circuitry 128, media playback circuitry 117, media streaming circuitry 127, for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
enabling sending of one or more notifications to one or more devices, the notifications comprising data informing the devices of an outstanding live sharing session;
enabling provision of one or more representations to the devices for selection, the representations relating in part to different representations of media content;
receiving one or more requests for removing at least one of the representations or for receipt of one or more other representations of the media content; and
enabling provision, via a processor, of a final media presentation description to the devices, based at least in part on the removed representations or the requested representations.

2. The method of claim 1, further comprising:
receiving one or more messages comprising information indicating one or more bandwidths associated with connections of the respective devices;
aggregating data of the bandwidths; and
offering an updated media presentation description to the devices, based in part on the aggregated data.

3. The method of claim 2, wherein the information of the messages comprises one more additional requested representations of the media content based in part of information of the bandwidths.

4. The method of claim 1, wherein the final media presentation description comprises information identifying one or more negotiated representations of the media content for sharing with at least one of the devices accepting an invitation to join the sharing session.

5. The method of claim 1, wherein the outstanding live sharing session corresponds to a current or future sharing session for sharing the media content with at least one of the devices accepting an invitation to join the live sharing session.

6. The method of claim 1, wherein the different representations correspond to at least one of a different bitrate, a different video resolution, a different audio resolution, or a different language associated with the media content.

7. The method of claim 1, wherein the data of the notification comprises information specifying a deadline for receiving the requests.

8. The method of claim 1, wherein enabling provision of the final media presentation further comprises removing unsupported representations from the provisioned representations, and wherein the method further comprises:
identifying one or more additional representations for inclusion in the final media presentation description based in part at least on one or more user or device preferences.

9. The method of claim 8, further comprising:
assigning at least one weight to the preferences;
increasing the weight of the preferences based on a number of times the devices request at least one representation of the additional representations; and
ordering the weighted preferences to determine a most preferred representation among the additional representations.

10. A computer program product comprising at least one tangible computer-readable memory having computer-executable program code instructions stored therein that, upon execution by the processor, cause the performance of the method of claim 1.

11. An apparatus comprising:
at least one processor; and
at least one memory including computer program code configured to, with the at least one processor, cause the apparatus to perform at least the following:
enable sending of one or more notifications to one or more devices, the notifications comprising data informing the devices of an outstanding live sharing session;
enable provision of one or more representations to the devices for selection, the representations relating in part to different representations of media content;
receive one or more requests for removing at least one of the representations or for receipt of one or more other representations of the media content; and
enable provision of a final media presentation description to the devices, based at least in part on the removed representations or the requested representations.

12. The apparatus according to claim 11, wherein the at least one memory and the computer program code are further configured to, with the at least one processor, cause the apparatus to:
receive one or more messages comprising information indicating one or more bandwidths associated with connections of the respective devices;
aggregate data of the bandwidths; and
offer an updated media presentation description to the devices, based in part on the aggregated data.

13. The apparatus of claim 12, wherein the information of the messages comprises one more additional requested representations of the media content based in part of information of the bandwidths.

14. The apparatus of claim 11, wherein the final media presentation description comprises information identifying one or more negotiated representations of the media content for sharing with at least one of the devices accepting an invitation to join the sharing session.

15. The apparatus of claim 11, wherein the outstanding live sharing session corresponds to a current or future sharing session for sharing the media content with at least one of the devices accepting an invitation to join the live sharing session.

16. The apparatus of claim 11, wherein the different representations correspond to at least one of a different bitrate, a different video resolution, a different audio resolution, or a different language associated with the media content.

17. The apparatus of claim 11, wherein the data of the notification comprises information specifying a deadline for receiving the requests.

18. The apparatus of claim 11, wherein the at least one memory and the computer program code are further configured to, with the at least one processor, cause the apparatus to:
enable provision of the final media presentation by removing unsupported representations from the provisioned representations; and
identify one or more additional representations for inclusion in the final media presentation description based in part at least on one or more user or device preferences.

19. The apparatus of claim 18, wherein the at least one memory and the computer program code are further configured to, with the at least one processor, cause the apparatus to:
assign at least one weight to the preferences;
increase the weight of the preferences based on a number of times the devices request at least one representation of the additional representations; and
order the weighted preferences to determine a most preferred representation among the additional representations.

20. A method comprising:
receiving a notification from a device, the notification comprising data indicating an outstanding live sharing session and a request for joining the session;
receiving one or more representations from the device, the representations relating in part to different representations of media content;
filtering, via a processor, the representations to request removal of at least one of the representations, among the representations, or request one or more other representations of the media content based at least in part on one or more device capabilities or one or more user preferences;
enabling sending of information indicating the filtered representations to the device; and
receiving a final media presentation description from the device based at least in part on the information indicating the filtered representations.

21. The method of claim 20, further comprising:
determining a throughput of a connection with a network;
generating a message comprising information indicating the throughput;
enabling provision of the generated message to the device; and
receiving an updated media presentation description based in part on the information indicating the throughput.

22. The method of claim 21, wherein the updated media presentation comprises data indicating at least one representation of the media content that is selected based in part on the throughput.

23. The method of claim 20, wherein the final media presentation description comprises information identifying one or more negotiated representations of the media content for sharing in response to accepting the request to join the sharing session.

24. The method of claim 20, wherein the outstanding live sharing session corresponds to a current or future sharing session for receiving the media content from the device in response to accepting the request to join the live sharing session.

25. A computer program product comprising at least one tangible computer-readable memory having computer-executable program code instructions stored therein that, upon execution by the processor, cause the performance of the method of claim 20.

26. An apparatus comprising:
at least one processor; and
at least one memory including computer program code configured to, with the at least one processor, cause the apparatus to perform at least the following:
receive a notification from a device, the notification comprising data indicating an outstanding live sharing session and a request for joining the session;
receive one or more representations from the device, the representations relating in part to different representations of media content;
filter the representations to request removal of at least one of the representations, among the representations, or request one or more other representations of the media content based at least in part on one or more device capabilities or one or more user preferences;
enable sending of information indicating the filtered representations to the device; and
receive a final media presentation description from the device based at least in part on the information indicating the filtered representations.

27. The apparatus of claim 26, wherein the at least one memory and the computer program code are further configured to, with the at least one processor, cause the apparatus to:
determine a throughput of a connection with a network;
generate a message comprising information indicating the throughput;
enable provision of the generated message to the device; and
receive an updated media presentation description based in part on the information indicating the throughput.

28. The apparatus of claim 27, wherein the updated media presentation comprises data indicating at least one representation of the media content selected based in part on the throughput.

29. The apparatus of claim 26, wherein the final media presentation description comprises information identifying one or more negotiated representations of the media content for sharing in response to accepting the request to join the sharing session.

30. The apparatus of claim 26, wherein the outstanding live sharing session corresponds to a current or future sharing session for receiving the media content from the device in response to accepting the request to join the live sharing session.
